(19) United States
(12) Patent Application Publication
(10) Pub. No.: US 2026/0277424 A1
(43) Pub. Date: Sep. 17, 2026

(54) MEDIA DATA PROCESSING METHOD AND APPARATUS, DEVICE, MEDIUM, AND PROGRAM PRODUCT

(71) Applicant: TENCENT TECHNOLOGY (SHENZHEN) COMPANY LIMITED, Shenzhen (CN)

(72) Inventors: Chushi WEI, Shenzhen (CN); Xing LIN, Shenzhen (CN); Ying QI, Shenzhen (CN); Hang KANG, Shenzhen (CN); Ziping HE, Shenzhen (CN)

(73) Assignee: TENCENT TECHNOLOGY (SHENZHEN) COMPANY LIMITED, Shenzhen (CN)

(21) Appl. No.: 19/671,486

(22) Filed: May 8, 2026

Related U.S. Application Data
(63) Continuation of application No. PCT/CN2025/083148, filed on Mar. 18, 2025.

(30) Foreign Application Priority Data
Apr. 25, 2024 (CN) 202410509428.2

(51) Int. Cl. G06F 3/04847; G06F 3/14

(52) U.S. Cl. CPC G06F 3/04847; G06F 3/14

(57) ABSTRACT

A media data processing method performed by a terminal device includes displaying a media interface configured to present a media stream; displaying an operation layer based on a negative feedback operation on first media data in the media stream, a negative feedback condition being presented on the operation layer; and displaying a negative feedback result for the first media data based on an operating status of the negative feedback operation meeting the negative feedback condition.

### CROSS-REFERENCE TO RELATED APPLICATIONS

The present disclosure is a bypass continuation application of International Patent Application No. PCT/CN2025/083148, filed on March 18, 2025, which claims priority to and is based on Chinese Patent Application No. 202410509428.2, filed on April 25, 2024, the disclosures of which are incorporated herein in their entireties by reference.

### FIELD

The present disclosure relates to the field of computer technologies, in particular, to the field of multimedia display, and specifically, to a media data processing method, a media data processing apparatus, a computer device, a computer-readable storage medium, and a computer program product.

### BACKGROUND

When browsing media data on a media interface, an object (e.g., a user) may give feedback that is negative (e.g., negative feedback) on the media data, to indicate that the object is not interested in a type of media data, subsequently reducing a probability of pushing the type of media data. However, currently, a negative feedback operation has a problem of high operation complexity. For example, a negative feedback (e.g., "not interested") function control (or option) is set, and the function control is set on a menu panel. When the object gives negative feedback on media data (e.g., a video) on the media interface, the object needs to first search for and invoke the menu panel, find the negative feedback function control on the menu panel, and then perform a trigger operation (e.g., a click operation, a selection operation) on the function control, so that the negative feedback may be completed. A negative feedback setting path is excessively long, and operation complexity is relatively high, resulting in relatively low efficiency of negative feedback on the media data. Complexitiy and efficency of feedback operations can be improved.

### SUMMARY

Some embodiments of the present disclosure provide a media data processing method and apparatus, a device, a medium, and a program product, to simplify operation complexity of a negative feedback operation and improve efficiency of negative feedback on media data.

Some embodiments of the present disclosure provide a media data processing method performed by a terminal device. The media data processing method may include displaying a media interface configured to present a media stream; displaying an operation layer based on a negative feedback operation on first media data in the media stream, a negative feedback condition being presented on the operation layer; and displaying a negative feedback result for the first media data based on an operating status of the negative feedback operation meeting the negative feedback condition.

Some embodiments of the present disclosure provide a media data processing apparatus including at least one memory configured to store computer program code; and at least one processor configured to read the program code and operate as instructed by the program code. The program code includes display code configured to cause the at least one processor to, display a media interface, the media interface being configured for presenting a media stream; display an operation layer based on a negative feedback operation on first media data in the media stream, a negative feedback condition being presented on the operation layer; and display a negative feedback result for the first media data based on an operating status of the negative feedback operation meeting the negative feedback condition.

Some embodiments of the present disclosure provide a non-transitory computer-readable storage medium, storing computer program code, when executed by at least one processor, causes the at least one processor to at least, display a media interface, the media interface being configured for presenting a media stream; display an operation layer based on a negative feedback operation on first media data in the media stream, a negative feedback condition being presented on the operation layer; and display a negative feedback result for the first media data based on an operating status of the negative feedback operation meeting the negative feedback condition.

### BRIEF DESCRIPTION OF THE DRAWINGS

The above and other aspects, features, and advantages of one or more embodiments of the present disclosure will be more apparent from the following description taken in conjunction with the accompanying drawings, in which:

FIG. 1 is an architectural diagram of a media data processing system of according to some embodiments of the present disclosure;

FIG. 2 is a schematic flowchart of a media data processing method according to some embodiments of the present disclosure;

FIG. 3a is a diagram of an interaction scenario according to some embodiments of the present disclosure;

FIG. 3b is a diagram of another interaction scenario according to some embodiments of the present disclosure;

FIG. 4 is a schematic flowchart of another media data processing method according to some embodiments of the present disclosure;

FIG. 5 is a diagram of another interaction scenario according to some embodiments of the present disclosure;

FIG. 6 is a diagram of another interaction scenario according to some embodiments of the present disclosure;

FIG. 7 is a diagram of another interaction scenario according to some embodiments of the present disclosure;

FIG. 8 is a diagram of another interaction scenario according to some embodiments of the present disclosure;

FIG. 9 is a diagram of another interaction scenario according to some embodiments of the present disclosure;

FIG. 10 is an interaction flowchart according to some embodiments of the present disclosure;

FIG. 11 is a schematic structural diagram of a media data processing apparatus according to some embodiments of the present disclosure;

FIG. 12 is a schematic structural diagram of a computer device according to some embodiments of the present disclosure;

### DETAILED DESCRIPTION

The term, involved in the following description, “some embodiments” describes subsets of all possible embodiments, but “some embodiments” may be the same subset or different subsets of all the possible embodiments and may be combined with each other without conflict.

The operations, techniques, and processes described herein may be implemented via executable instructions or computer program code stored on computer-readable medium. Such computer program code may include distinct portions or modules, where each portion comprises a subset of the total instructions necessary to perform specific operations.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “set” (e.g., “a set of items”) or “subset” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

An expression, “a and/or b” may be understood as including only a, only b and both a and b. Expressions “at least one of a, b, and c” and “at least one of a, b, or c” may be understood as including only a, only b, only c, both a and b, both a and c, both b and c, or all of a, b, and c.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

With regard to the description of the drawings, similar reference numerals may be used to refer to similar or related components.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

A media interface is an interface shown when a media stream is presented. A media application may be run on a terminal device. The media interface may be carried by the media application run on the terminal device, e,g., the media interface may be any interface in the media application. The media application is an application having a media play function. Exemplarily, the media application may be presented in a form of an application program. In an implementation, the application program may be a client installed on a terminal device, and the client is a software application program installed and run on the terminal device. In another implementation, the application program may alternatively be an installation-free application program, e,g., a lightweight application program that may be used without being downloaded and installed. This type of application program may alternatively be referred to as a mini program. The mini program runs in a client as a sub-program. The client is referred to as a parent application, and a sub-program run in the client is referred to as a sub-application. In another implementation, the application program may alternatively be a web application program opened through a browser, or the like.

In embodiments of the present disclosure, the media stream may include one or more pieces of media data, the pieces of media data in the media stream are arranged in sequence, and an arrangement sequence of media data in the media stream may be configured for indicating a display sequence of the media data. For example, the media stream includes media data 0, media data 1, and media data 2 arranged in sequence. This means that a display sequence of the media data 0 precedes a display sequence of the media data 1, and the display sequence of the media data 1 precedes a display sequence of the media data 2. Alternatively, the arrangement sequence of the media data in the media stream may be configured for indicating a generation (or publishing) time sequence of the media data in the media application. The media stream includes the media data 0, the media data 1, and the media data 2 arranged in sequence. This means that generation (or publishing) time of the media data 0 is earlier than generation (or publishing) time of the media data 1, and the generation (or publishing) time of the media data 1 is earlier than generation (or publishing) time of the media data 2. Content of any piece of media data may include, but is not limited to, all content that may be dynamically presented on the media interface, such as video content (e,g., a short video), audio content (e,g., music), text content (e.g., an article or a sentence), and image content (e,g., a painted work). The media interface is an interface that may respond to an interaction operation of an object. For example, the object may perform a swipe-up operation, a pull-down operation, or the like along the media interface to view each piece of media data in the media stream. A first media data in some embodiments of the present disclosure may be any piece of media data in the media stream. Exemplarily, the first media data may be media data being displayed on the media interface.

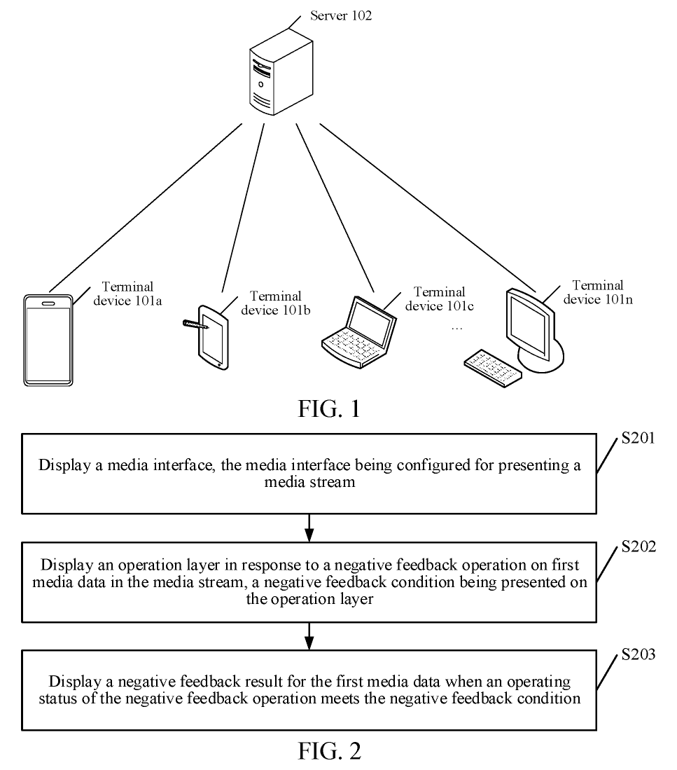

Referring to FIG. 1, FIG. 1 is an architectural diagram of a media data processing system according to some embodiments of the present disclosure. The system includes a terminal device cluster and a server 102. The terminal device cluster may include one or more terminal devices. As shown in FIG. 1, the plurality of terminal devices may include a terminal device 101a, a terminal device 101b, a terminal device 101c, …, and a terminal device 101n. A quantity of terminal devices in the terminal device cluster is not limited herein. The terminal device 101a, the terminal device 101b, the terminal device 101c, …, and the terminal device 101n may have a direct or indirect network connection to the server 102 in a wired or wireless communication manner, so that each terminal device may exchange data with the server 102 through the network connection.

A type of any terminal device in the terminal device cluster may include, but is not limited to, a smartphone, a tablet computer, an intelligent wearable device, an intelligent voice interaction device, an intelligent appliance, a personal computer, an in-vehicle terminal, an intelligent camera, a virtual reality device (e,g., an augmented reality (AR) device), and the like. This is not limited in the present disclosure. Each terminal device in the terminal device cluster shown in FIG. 1 may run a media application. When being run on each terminal device, the media application may exchange data with the server 102 shown in FIG. 1. Exemplarily, the media application may include an application having a media play function, such as a browser, an in-vehicle application, a smart home application, an entertainment application, a multimedia application (e.g., a short video application and a live streaming application), a social application, and an information application.

The server 102 is a serving device configured to provide a media play service. Exemplarily, the server 102 may be a background server of the media application. The server 102 may be an independent physical server, or may be a server cluster or a distributed system including a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform, which is not limited herein.

An object is a user of a terminal device, or a user of a media application on the terminal device. Exemplarily, when the object intends to view media data in a media stream, the object may trigger (e,g., click on) a media application icon on the terminal device. After detecting a trigger operation on the media application icon, the terminal device starts the media application corresponding to the media application icon and displays a media interface and requests the server 102 to obtain the media stream. After the server 102 delivers the media stream to the terminal device by using a real-time streaming protocol, the terminal device displays each piece of media data in the media stream on the media interface. The real-time streaming protocol (RTSP) is a network protocol and is configured for controlling transmission of streaming media.

In addition to displaying each piece of media data in the media stream, the media interface may further display attached content related to the media data. The attached content related to the media data may include, but is not limited to, any one or more of the following: publishing information of the media data (e.g., publisher information and publishing time), playing progress information of the media data (which indicates a percentage of an amount of time for which the media data has been played in a total time length), interaction information of the media data (e.g., a quantity of likes, favorites, and shares obtained by the media data), and the like.

When the first media data (any piece of media data in the media stream) is displayed on the media interface, the object finds that an interest level for the first media data is relatively low, and may perform a negative feedback operation on the first media data. In this case, the terminal device may display an operation layer in response to the negative feedback operation. The negative feedback operation is a predetermined interaction operation on the media interface. Exemplarily, the negative feedback operation may be a swipe operation (e,g., a swipe operation whose swiping speed is less than a preset speed) along the media interface. Exemplarily, the negative feedback operation may be a floating gesture operation (namely, an operation of not touching a screen of the terminal device). Exemplarily, the negative feedback operation may alternatively be any preset operation, e,g., a touch operation including a particular track on the media interface. Unless specifically described, some embodiments of the present disclosure is described by using an example in which the negative feedback operation is the swipe operation along the media interface.

In the system shown in FIG. 1, the terminal device may display the media interface, where the media interface is configured for presenting the media stream. In a process in which the first media data in the media stream is being displayed on a terminal interface, if the negative feedback operation on the first media data is detected (e,g., the swipe operation whose swiping speed along the media interface is less than the preset speed is detected), the operation layer may be displayed in response to the negative feedback operation. A layer is a manner for organizing and managing an interface element on a user interface (UI). The operation layer in some embodiments of the present disclosure is a component or a plane that appears during a specific operation (e,g., the negative feedback operation) and that can perform interaction with the object in a form. A negative feedback condition is presented on the operation layer, and the negative feedback condition is a condition configured for guiding an operating status of the negative feedback operation to cause negative feedback to succeed. Exemplarily, the negative feedback condition may be configured for prompting to dynamically adjust an operation position of the negative feedback operation to a region of the operation layer, to successfully perform negative feedback on the first media data. In this way, through the negative feedback condition, the object may be guided to adjust the operating status (e,g., the operation position) of the negative feedback operation, to give negative feedback on the first media data . When the operating status of the negative feedback operation meets the negative feedback condition (e,g., it is detected that the operation position of the negative feedback operation is in the region of the operation layer), a negative feedback result (e,g., information configured for prompting that negative feedback succeeds) for the first media data may be displayed. Subsequently, the server 102 reduces pushing of media data with a same type as the first media data.

In view of this, in some embodiments of the present disclosure, when performing negative feedback on the media data, the object only needs to simply perform the negative feedback operation along the media interface to wait for the operation layer to actively appear, and the object does not need to additionally search for a menu or function, thereby shortening a negative feedback setting path. Through the negative feedback condition presented on the operation layer, the operating status of the negative feedback operation may be guided, thereby simplifying operation complexity of the negative feedback operation. Through guidance of the negative feedback condition, the negative feedback result for the first media data may be smoothly obtained, thereby implementing efficient negative feedback on media data, and effectively improving efficiency of negative feedback on the media data.

The media data processing system and the media data processing method implemented based on the media data processing system in some embodiments of the present disclosure may be applied to various media pushing scenarios. The media pushing scenarios may include, but are not limited to, a live streaming scenario, a short video scenarios, a content sharing scenario, and the like. For example, in the live streaming scenario, the media data in the media stream is live streaming media data in a live streaming room. When the object is not interested in the live streaming room, negative feedback on the live streaming room may be implemented, to reduce pushing of live streaming rooms of the same type. In the short video scenario, the media data in the media stream is a short video (video data that is recorded in advance and that ranges from several seconds to several minutes). When the object is not interested in the short video, negative feedback on the short video may be implemented , to reduce pushing of short videos of the same type. In the content sharing scenario, the media data in the media stream is content pushing data (e,g., a share in a manner e.g., text, an image, or a video note). When the object is not interested in the content pushing data, negative feedback on the content pushing data may be implemented , to reduce pushing of content pushing data of the same type.

In some embodiments of the present disclosure, related data collection and processing are to be strictly performed based on requirements of related laws and regulations. Obtaining of personal information needs to be informed or agreed to by a personal subject (or has a legal basis for obtaining information), and subsequent data use and processing behaviors are performed within the laws and regulations and the authorization scope of the personal information subject. For example, when some embodiments of the present disclosure are applied to a specific product or technology, permission or agreement of an object needs to be obtained, and collection, use, and processing of related data needs to comply with related laws, regulations, and standards in a related region.

The following describes the media data processing method provided in some embodiments of the present disclosure.

One or more components of FIG. 1 may be integrated into a single component, or conversely, a single component may be implemented as multiple discrete elements. Additionally or alternatively, different subsets of the illustrated components may be combined in various configurations.

Referring to FIG. 2, FIG. 2 is a schematic flowchart of a media data processing method according to some embodiments of the present disclosure. In some embodiments, operations may be performed sequentially, in a different order, in parallel, or with some operations skipped or repeated. The media data processing method may be performed by a terminal device, for example, may be performed by any terminal device in the terminal device cluster shown in FIG. 1. The media data processing method includes, but is not limited to, operations S201 to S203.

S201: Display a media interface, the media interface being configured for presenting a media stream.

A media application is run on the terminal device. The media interface may be any interface in the media application, and may include, but is not limited to, a main interface of the media application, a media pushing interface of the media application, a personal home page interface of the media application, a collection presentation interface of favorites of the media application, a collection presentation interface of shares of the media application, and the like. The media interface may be configured for presenting the media stream. The media stream includes a plurality of pieces of media data. The pieces of media data in the media stream are arranged in sequence. An object may switch to view the pieces of media data in the media stream through a switch operation. Exemplarily, the media stream includes media data 0, media data 1, and media data 2 arranged in sequence. The media data 1 is currently displayed on a media interface of a short video application. In response to a swipe-up operation of the object along the media interface, the media data 2 may be switched to be displayed (namely, switched to next media data of the media data 1 in the media stream). In response to a pull-down operation of the object along the media interface, the media data 0 may be switched to be displayed (namely, switched to previous media data of the media data 1 in the media stream). The media data may be transmitted by a server or may be locally stored by the terminal device. A data type of the media data may include one or more of the following: text, audio, a video, an image, and the like. When the data type of the media data is the video or audio, only one piece of media data in the media stream is displayed on the media interface, and each piece of media data in the media stream may be switched to be displayed through the switch operation (e.g.., the swipe-up operation or the pull-down operation along the media interface in the foregoing example). When the data type of the media data is the text or image, one or more pieces of media data in the media stream may be displayed on the media interface. For example, one group of (a plurality of) images are synchronously displayed on the media interface, and the images are switched to be displayed by group through the switch operation (e.g.., a swipe-left operation or a swipe-right operation along the media interface).

S202: Display an operation layer in response to a negative feedback operation on first media data in the media stream, a negative feedback condition being presented on the operation layer.

In some embodiments of the present disclosure, "in response to" is configured for indicating a condition or status on which an action (e,g., displaying an operation layer) is performed. When the condition or status on which the action is performed is met, the performed action may be in real time or may have a set delay. The first media data may be media data being displayed on the media interface, or may be any piece of media data in the media stream. When only the first media data is currently displayed on the media interface, a negative feedback operation performed by the object may be the negative feedback operation on the first media data. When the plurality of pieces of media data (including the first media data) are currently displayed on the media interface, the object needs to indicate media data targeted by the negative feedback operation. For example, the object may mark the first media data as selected (e,g., by performing a long-press operation on the first media data). When the object performs negative feedback operation along the media interface, it may be determined that the object performs the negative feedback operation on the first media data.

When browsing media data that the object does not like, the object may trigger display of the operation layer through the negative feedback operation. The negative feedback operation is a predetermined interaction operation. Exemplarily, the negative feedback operation may be set as a swipe operation along the media interface. Considering that on an existing media interface, the swipe operation is configured to trigger switching of the media data, when the negative feedback operation is set as the swipe operation along the media interface, whether an intention of the object is to browse other media data (namely, switch displayed media data) or give negative feedback on currently browsed media data needs to be recognized. In a feasible implementation, the intention of the object may be recognized based on operation duration and an operation distance of the negative feedback operation. For example, if the operation distance of the negative feedback operation is less than a first preset distance threshold, or the operation duration of the negative feedback operation is less than a first preset duration threshold, it may be recognized that the intention of the object is to browse the other media data that is, switch the displayed media data). On the contrary, if the operation distance of the negative feedback operation reaches the first preset distance threshold, and the operation duration of the negative feedback operation reaches the first preset duration threshold, it may be recognized that the intention of the object is to give negative feedback on the currently browsed media data. The first preset distance threshold may be manually set (e,g., set based on an operation habit of the object), or set by a system (e,g., set based on system experience or a statistical result). The first preset duration threshold may also be manually set, or set by the system. The setting manner is not limited in the present disclosure. In this operation, when the negative feedback operation is detected, the operation duration and the operation distance of the negative feedback operation may be obtained, where the operation duration is a time period collected from a start time point of the operation, and the operation distance is a linear distance from a start position of the operation on the media interface to a placement position of the operation on the media interface. When the operation distance of the negative feedback operation reaches the first preset distance threshold and the operation duration of the negative feedback operation reaches the first preset duration threshold, it may be determined that the object needs to perform negative feedback. In this case, the operation layer is displayed.

In an implementation, that the operation layer is displayed when the operation distance of the negative feedback operation reaches the first preset distance threshold and the operation duration of the negative feedback operation reaches the first preset duration threshold includes: when the operation distance of the negative feedback operation is equal to the first preset distance threshold, determining whether the operation duration of the negative feedback operation is greater than or equal to the first preset duration threshold; and displaying the operation layer if the operation duration of the negative feedback operation is greater than or equal to the first preset duration threshold. For example, the first preset duration threshold is three seconds, and the first preset distance threshold is three centimeters. When the operation distance of the negative feedback operation reaches three centimeters, it is obtained that the operation duration of the negative feedback operation is five seconds (greater than three seconds). In this case, the operation layer may be displayed. In another implementation, that the operation layer is displayed when the operation distance of the negative feedback operation reaches the first preset distance threshold and the operation duration of the negative feedback operation reaches the first preset duration threshold includes: when the operation duration of the negative feedback operation is equal to the first preset duration threshold, determining whether the operation distance of the negative feedback operation is greater than or equal to the first preset distance threshold; and displaying the operation layer if the operation distance of the negative feedback operation is greater than or equal to the first preset distance threshold. For example, the first preset duration threshold is three seconds, and the first preset distance threshold is three centimeters. When the operation duration of the negative feedback operation reaches three seconds, it is obtained that the operation distance of the negative feedback operation is five centimeters (greater than three centimeters). In this case, the operation layer may be displayed.

In another feasible implementation, the intention of the object may be recognized based on an operation speed of the negative feedback operation. For example, if the operation speed of the negative feedback operation is greater than or equal to a preset speed, it may be recognized that the intention of the object is to browse the other media data (e,g., switch the displayed media data). On the contrary, if the operation speed of the negative feedback operation is less than the preset speed, it may be recognized that the intention of the object is to give the negative feedback on the currently browsed media data. The operation speed is configured for reflecting a value of the operation distance within unit duration. Exemplarily, when the negative feedback operation is set as a swipe operation, the operation speed of the negative feedback operation is a swiping speed.

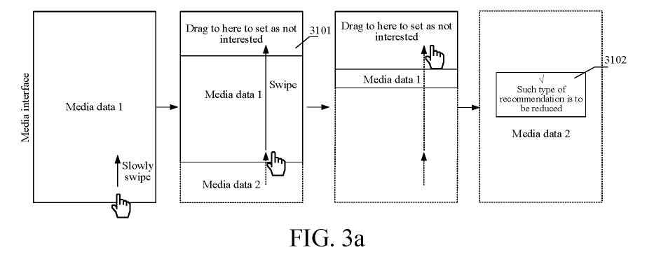

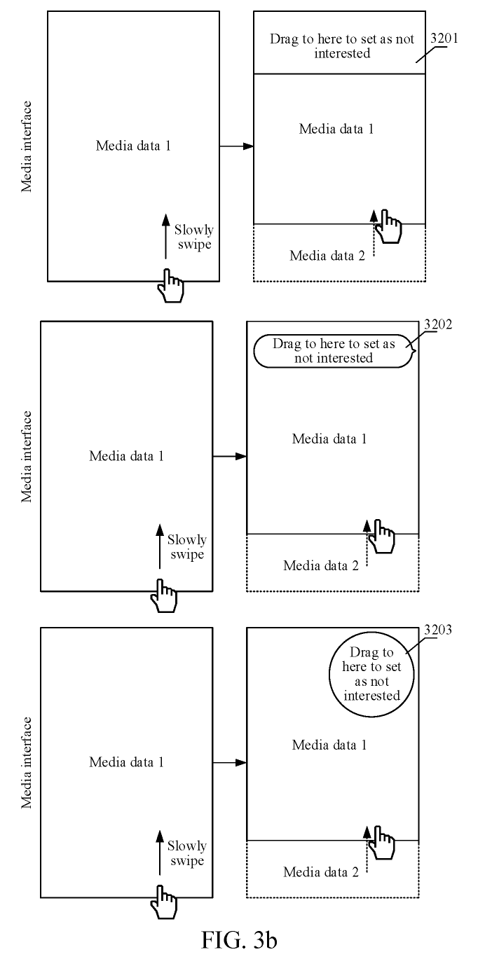

When it is recognized that the intention of the object is to switch the displayed media data on the media interface, switching of the media data may be determined based on an operation direction of the negative feedback operation. The operation direction of the negative feedback operation includes, but is not limited to, any one or more of the following: swiping up (swiping from bottom to top along the media interface (or along the screen of the terminal device)), swiping down (swiping from top to bottom along the media interface (or along the screen of the terminal device)), swiping left (swiping from right to left along the media interface (or along the screen of the terminal device)), and swiping right (swiping from left to right along the media interface (or along the screen of the terminal device)). As shown in FIG. 3a (which is a diagram of an interaction scenario according to some embodiments of the present disclosure), when the operation direction of the negative feedback operation is swiping up, next media data (namely, media data 2) of media data 1 in the media stream may be displayed.

In view of this, in some embodiments of the present disclosure, the negative feedback operation may be set as the swipe operation along the media interface, and a method for determining the intention of the object based on the swipe operation is designed. The intention of the object is recognized based on an operating status of the swipe operation, to determine whether to display the operation layer or switch the media data. Such a design may avoid affecting an original interaction function of the media interface, and may also enable the object to give negative feedback based on an existing, natural, and habitual operation.

In an implementation, a display position of the operation layer may be any position on the media interface. Exemplarily, the display position of the operation layer may be determined based on the operation direction of the negative feedback operation. When the operation direction of the negative feedback operation is swiping up, the display position of the operation layer may be located at an upper edge of the media interface. When the operation direction of the negative feedback operation is swiping down, the display position of the operation layer may be located at a lower edge of the media interface. When the operation direction of the negative feedback operation is swiping right, the display position of the operation layer may be located at a left edge of the media interface. When the operation direction of the negative feedback operation is swiping left, the display position of the operation layer may be located at a right edge of the media interface. In another implementation, the display position of the operation layer may be a preset fixed display position. Therefore, when the operation direction of the negative feedback operation is a direction pointing to the fixed display position, display of the operation layer may be triggered. For example, the preset fixed display position is the upper edge of the media interface. When it is detected that the negative feedback operation is the swipe-up operation, the operation layer is displayed on the upper edge of the media interface.

A display level of the operation layer is higher than a display level of the media interface, e,g., the operation layer is displayed on an upper layer of the media interface, to implement interaction with the object based on the operation layer. Exemplarily, the operation layer may be a component of any shape displayed in a floating layer form (or referred to as an active panel). As shown in FIG. 3b (which is a diagram of an interaction scenario according to some embodiments of the present disclosure), the operation layer includes a floating frame 3201, a floating bubble 3202, and a floating ball 3203 displayed in the floating layer form. The operation layer may be displayed in an opaque (whose transparency is 0%) form, or may be displayed in a translucent (whose transparency is 50%) form. A color of the operation layer may be any color. A display form (e,g., transparency or a color) of the operation layer is not limited in the present disclosure.

A region area of the operation layer may be smaller than an area of a display region of the media interface. As shown in FIG. 3a, an operation layer 3101 may occupy only a small part of the media interface. In this way, interference generated by the operation layer with the media interface may be reduced. In some embodiments, when dynamic modification of the region area of the operation layer is not allowed, a larger region area may be set for the operation layer, to facilitate interaction between the object and the operation layer. The negative feedback condition is presented on the operation layer. Exemplarily, the negative feedback condition may be configured for prompting the object that if the object expects to give negative feedback on the first media data, the negative feedback operation may be kept uninterrupted, and the operation position of the negative feedback operation is dynamically adjusted to the region of the operation layer.

S203: Display a negative feedback result for the first media data when the operating status of the negative feedback operation meets the negative feedback condition.

In an implementation, when the operation position of the negative feedback operation enters the region of the operation layer after being dynamically adjusted, it may be determined that the operating status of the negative feedback operation meets the negative feedback condition, the negative feedback result for the first media data is displayed, and the operation layer may be hidden. The negative feedback result may be configured for indicating that the negative feedback on the first media data succeeds. That the negative feedback succeeds indicates that an interest level of the object initiating the negative feedback operation on the first media data is less than an interest threshold (e,g., it indicates that the object is not interested in the first media data). A form of the negative feedback result includes, but is not limited to, vibration feedback, audio-visual feedback, and graphic-textual feedback. For example, the negative feedback result includes vibration and text (e,g., text information like "Such type of recommendation is to be reduced"). The object may revoke the negative feedback operation after receiving the negative feedback result. Hiding the operation layer may include deleting the operation layer, or setting the transparency of the operation layer to 100% (in this case, the display level of the operation layer further needs to be adjusted to be lower than the display level of the media interface, to avoid that an interaction operation on the media interface is incorrectly determined as an interaction operation on the operation layer).

In an implementation, when the negative feedback result of the first media data indicates that the negative feedback on the first media data succeeds, the first media data may be deleted from the media stream, and the first media data displayed on the media interface is switched to second media data. The second media data may be selected based on the operation direction of the negative feedback operation and an arrangement sequence of each piece of media data in the media stream. For example, if the operation direction of the negative feedback operation is swiping up, the media data 1 on the media interface may be switched to the next media data 2 of the media data 1 in the media stream for display. If the operation direction of the negative feedback operation is swiping down, the media data 1 on the media interface may be switched to previous media data 0 of the media data 1 in the media stream for display.

When the negative feedback result of the first media data indicates that the negative feedback on the first media data succeeds, the terminal device may reduce pushing of media data with a same type as the first media data. For example, the server obtains a target category to which the first media data belongs, and deletes, from the media stream, media data belonging to the target category, to obtain an updated media stream; and the terminal device may play the updated media stream. In some embodiments, after deleting, from the media stream, the media data belonging to the target category, the server may further add, to the media stream, some other media data not belonging to the target category, to obtain an updated media stream. The target category of the first media data may include any one or more of the following: a label self-defined when the first media data is uploaded, or a label marked through manual content analysis and machine content analysis. Exemplarily, referring to the schematic interaction diagram shown in FIG. 3a, when a finger of the object performs a negative feedback operation of swiping up along the media interface, the operation layer 3101 (presented in a form of a floating window) may be displayed on the upper edge of the media interface, and a negative feedback condition, for example, text "Drag to here to set as not interested" is displayed on the operation layer 3101. The operation layer 3101 may descend along the media interface as the object swipes up, to get close to the finger of the object, and the object may continue to swipe up until the finger enters a region of the operation layer 3101 (e.g.., the operation position of the negative feedback operation enters the region of the operation layer 3101). In this way, the negative feedback operation meets the negative feedback condition. In this case, a negative feedback result 3102 may be displayed. For example, the negative feedback result 3102 includes text "Such type of recommendation is to be reduced", to prompt that the negative feedback succeeds. The object may remove the finger from the media interface.

When the operating status of the negative feedback operation does not meet the negative feedback condition (e,g., the operation position of the negative feedback operation does not enter the region of the operation layer), the negative feedback operation is revoked. For example, before the finger of the object enters the region of the operation layer 3101 shown in FIG. 3a, the object loosens the finger from the media interface, so that the negative feedback operation is revoked. This indicates that the object gives up performing negative feedback on the first media data, and the operation layer may be hidden. In this case, the first media data displayed on the media interface may further be switched to other media data based on the operation direction of the negative feedback operation and the arrangement sequence of each piece of media data in the media stream.

In some embodiments of the present disclosure, a media interface may be displayed. The media interface is configured for presenting a media stream. When a negative feedback operation on first media data in the media stream is detected, an operation layer is displayed, where a negative feedback condition is presented on the operation layer. In view of this, in the present disclosure, the operation layer may be actively displayed after a negative feedback intention of an object is recognized, and the object does not need to additionally search for a menu or function, thereby shortening a negative feedback setting path. In addition, the negative feedback condition is further presented on the operation layer. The negative feedback condition can guide an operating status of the negative feedback operation, thereby simplifying operation complexity of the negative feedback operation. A negative feedback result for the first media data is displayed when the operating status of the negative feedback operation meets the negative feedback condition. Through guidance of the negative feedback condition, the negative feedback result for the first media data may be smoothly obtained, thereby implementing efficient negative feedback on media data, and effectively improving efficiency of negative feedback on the media data.

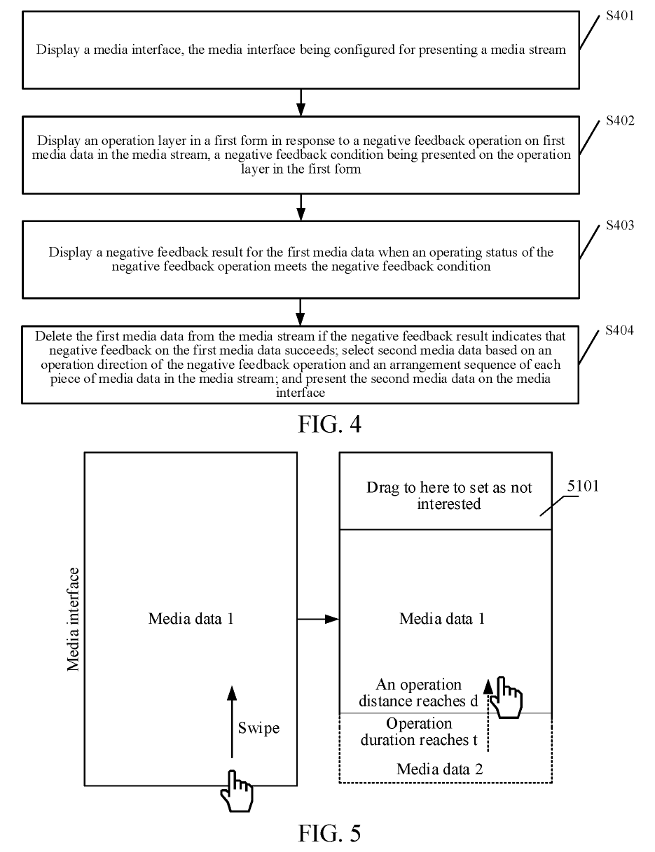

Referring to FIG. 4, FIG. 4 is another schematic flowchart of a media data processing method according to some embodiments of the present disclosure. In some embodiments, operations may be performed sequentially, in a different order, in parallel, or with some operations skipped or repeated. The media data processing method may be performed by a terminal device, for example, may be performed by any terminal device in the terminal device cluster shown in FIG. 1. The media data processing method includes, but is not limited to, operations S401 to S404.

S401: Display a media interface, the media interface being configured for presenting a media stream.

The media stream is a data form that continuously provides content, and includes, but is not limited to, a video data stream (including one or more pieces of video data), an audio data stream (including one or more pieces of audio data), a text data stream (including one or more pieces of text data), and an image data stream (including one or more pieces of image data). The media stream may be presented by a media interface of the media application. The media interface of the media application may be any interface that can display media data, such as a media pushing interface of the media application, a personal home page interface of the media application, a collection presentation interface of favorites of the media application, and a collection presentation interface of shares of the media application. The media application may include, but is not limited to, an application having a media play service, such as a social application program, a live streaming application program, an audio/video application program, an education application program, or a shopping application program. Currently, a relatively popular media application is mostly a short video application. A main working principle of the short video application is that a terminal device of the short video application pulls a media stream (including a plurality of short videos) from a server and displays the media stream on the media interface of the media application, and an object may switch to play each short video by performing a switching operation on the media interface (such as a swiping-up operation or a pull-down operation along the media interface). In some embodiments of the present disclosure, the short video application is used as an example for description.

S402: Display an operation layer in a first form in response to a negative feedback operation on first media data in the media stream, the operation layer in the first form presenting a negative feedback condition.

A display level of the operation layer in the first form may be higher than a display level of the media interface. Exemplarily, the operation layer in the first form is a component that is of any shape and that is displayed in a floating layer form (or referred to as an active panel). For example, the operation layer is a floating frame, a floating bubble, a floating ball, or the like that is displayed in the floating layer form. In some embodiments of the present disclosure, an example in which the operation layer in the first form is the floating frame is used for description. The operation layer may be displayed in an opaque form, or may be displayed in a translucent form. A color of the operation layer may be any color. This is not limited in the present disclosure. A region area of the operation layer in the first form is smaller than a region of a display area of the media interface. The negative feedback condition is presented on the operation layer in the first form. Exemplarily, the negative feedback condition may be configured for prompting the object that if the object expects to initiate negative feedback to the first media data, the negative feedback operation may be kept uninterrupted, and the operation position of the negative feedback operation is dynamically adjusted to be in the region of the operation layer.

The first media data is media data that is being displayed on the media interface. An example in which the first media data is displayed on the media interface, and the negative feedback operation is a swipe operation along the media interface is used for description. In some embodiments of the present disclosure, when the swipe operation on the media interface is detected, it may be determined that the negative feedback operation on the first media data in the media stream is detected, and the operating status (e,g., including operation duration and an operation distance of the negative feedback operation) of the negative feedback operation may be obtained. The operation layer in the first form is displayed when the operation duration of the negative feedback operation reaches a first preset duration threshold and the operation distance of the negative feedback operation reaches a first preset distance threshold. That the operation duration of the negative feedback operation reaches a first preset duration threshold includes that the operation duration of the negative feedback operation is greater than or equal to the first preset duration threshold. That the operation distance of the negative feedback operation reaches a first preset distance threshold includes that the operation distance of the negative feedback operation is greater than or equal to the first preset distance threshold.

In an implementation, when the operation distance of the negative feedback operation is equal to the first preset distance threshold, whether the operation duration of the negative feedback operation is greater than or equal to the first preset duration threshold may be determined, and if the operation duration of the negative feedback operation is greater than or equal to the first preset duration threshold, the operation layer in the first form is triggered to be displayed. Alternatively, when the operation duration of the negative feedback operation is equal to the first preset duration threshold, whether the operation distance of the negative feedback operation is greater than or equal to the first preset distance threshold may be determined, and if the operation distance of the negative feedback operation is greater than or equal to the first preset distance threshold, the operation layer in the first form is displayed.

In a feasible implementation, the operating status of the negative feedback operation may further include an operation direction of the negative feedback operation. When swiping duration of the negative feedback operation does not reach the first preset duration threshold (namely, the operation duration of the negative feedback operation is less than the first preset duration threshold), or the operation distance of the negative feedback operation does not reach the first preset distance threshold (namely, the operation distance of the negative feedback operation is less than the first preset distance threshold), if the negative feedback operation is recalled, the media data may be selected based on the operation direction of the negative feedback operation based on the arrangement sequence of each piece of media data in the media stream, and the selected media data is presented on the media interface. The operation direction of the negative feedback operation includes, but is not limited to, any one or more of the following operations: swiping up, swiping down, swiping leftward, and swiping rightward. For example, the media stream includes media data 0, media data 1, and media data 2 arranged in sequence. The operation direction of the negative feedback operation is swiping up, and the media data 1 currently displayed on the media interface may be switched to the media data 2 following the media data 1 in the media stream. If the operation direction of the negative feedback operation is swiping down, the media data 1 currently displayed on the media interface may be switched to the media data 0 preceding the media data 1 in the media stream.

For example, reference may be made to a diagram of an interaction scenario shown in FIG. 5. Assuming that the first preset duration threshold is t (greater than 0) seconds, and the first preset distance threshold is d (greater than 0) centimeters, as shown in FIG. 5, when an operation distance for which a finger of the object swipes upward on the media interface reaches d centimeters, operation duration from when the finger of the object lands on the media interface to when the finger of the object swipes for d centimeters may be obtained. When the operation duration is greater than or equal to t seconds, an operation layer 5101 in the first form is displayed. If the finger of the object leaves the media interface without swiping for d centimeters, or the obtained operation duration is less than t seconds, next piece of media data (namely, the media data 2) of the media data 1 in the media stream may be pulled and displayed on the media interface.

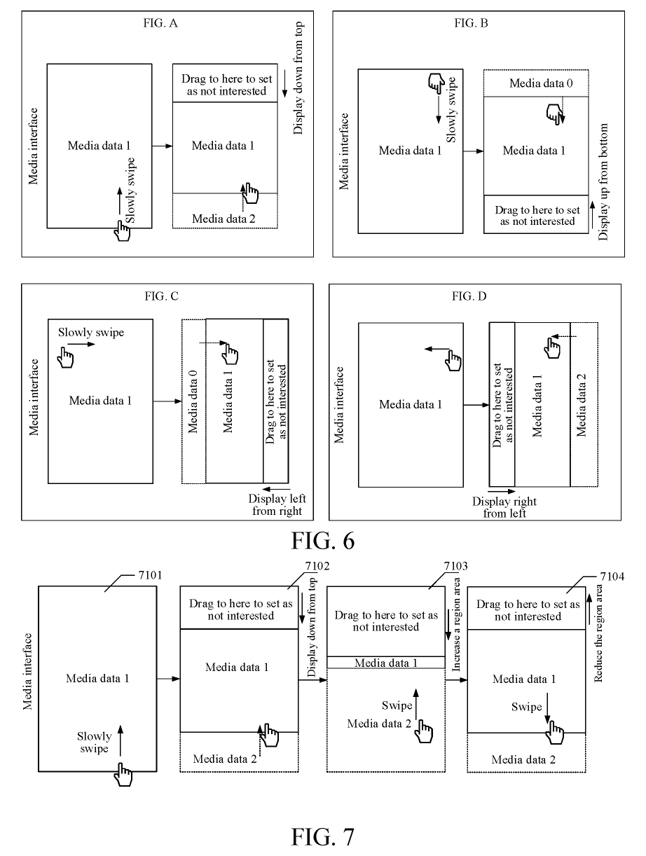

In some embodiments, the operation direction of the negative feedback operation includes a first direction along the media interface, and the first direction may be any direction on the media interface. In some embodiments of the present disclosure, the operation layer in the first form may be displayed in a second direction along the media interface. The second direction may be different from the first direction, namely, the second direction is any direction different from the first direction. For example, the first direction is an upward direction along bottom, and the second direction may be a direction from left to right. Alternatively, the second direction is an opposite direction of the first direction. As shown in FIG. A in FIG. 6, when the operation direction of the negative feedback operation is swiping up, the operation layer in the first form may be displayed on the media interface in a direction from top to bottom. As shown in FIG. B in FIG. 6, when the operation direction of the negative feedback operation is swiping down, the operation layer in the first form may be displayed on the media interface in a direction from bottom to top. As shown in FIG. C in FIG. 6, when the operation direction of the negative feedback operation is swiping rightward, the operation layer in the first form may be displayed on the media interface in a direction from right to left. As shown in FIG. D in FIG. 6, when the operation direction of the negative feedback operation is swiping leftward, the operation layer in the first form may be displayed on the media interface in a direction from left to right. In some embodiments of the present disclosure, for the operation interface in the first form, a display manner that is more object-friendly and conforms to intuition of the object is designed.

In a feasible implementation, a display position of the operation layer is a preset fixed display position. Therefore, when the operation direction of the negative feedback operation is a direction pointing to the fixed display position, display of the operation layer in the first form may be triggered. If the operation layer in the first form is displayed on an upper edge of the media interface, when it is detected that the negative feedback operation is the swipe operation of swiping up along the media interface, the operation layer in the first form is displayed on the upper edge of the media interface.

In some embodiments, when the operation distance of the negative feedback operation changes, a display form of the operation layer in the first form may be controlled to change with change of the operation distance of the negative feedback operation. The operation distance of the negative feedback operation refers to a distance for swiping in a direction pointing to the operation layer in the first form. Synchronously increase a region area of the operation layer in the first form with increase of the operation distance of the negative feedback operation when the operation distance of the negative feedback operation is greater than the first preset distance threshold. As shown in 7101 and 7102 in FIG. 7 (which is a diagram of an interaction scenario according to some embodiments of the present disclosure), when the finger of the object swipes upward on the media interface, the operation distance and the operation duration of the negative feedback operation may be obtained. When the operation distance of the negative feedback operation reaches the first preset distance threshold, and the operation duration of the negative feedback operation reaches the first preset duration threshold, the operation layer in a first form that is displayed from top to bottom (namely, an interface shown in 7102 in FIG. 7) may be triggered on the media interface. When the negative feedback operation continues to swipe up, a height of the operation layer in the first form gradually increases as the swiping distance increases (namely, an interface shown in 7103 in FIG. 7), to accommodate the finger of the object, so that the object can conveniently perform operation. In addition, the region area of the operation layer in the first form may be synchronously reduced with decrease of the operation distance of the negative feedback operation when the operation distance of the negative feedback operation is greater than the first preset distance threshold. As shown in 7104 in FIG. 7 (which is a diagram of an interaction scenario according to some embodiments of the present disclosure), when the negative feedback operation swipes down, as the swiping distance decreases, the height of the operation layer in the first form gradually increases, to move away from the finger of the object.

In some embodiments, when the region area of the operation layer in the first form is increased, the increased area within unit duration may be determined based on an operation speed of the negative feedback operation. For example, the increased area within the unit duration may have a positive correlation with the operation speed of the negative feedback operation. For example, the operation layer in the first form is a floating frame. The faster the negative feedback operation, the faster a height of the floating frame may increase while keeping a width of the floating frame constant. The slower the negative feedback operation, the slower the height of the floating frame may increase. Alternatively, the region area of the operation layer in the first form may be increased at a constant speed. For example, the operation layer in the first form is a floating frame. As the operation distance of the negative feedback operation increases, the height of the floating frame may be increased at a constant speed.

In some embodiments, when the region area of the operation layer in the first form is reduced, the reduced area within unit duration may be determined based on an operation speed of the negative feedback operation. For example, the reduced area within the unit duration may have a positive correlation with the operation speed of the negative feedback operation. For example, the operation layer in the first form is a floating frame. The faster the negative feedback operation, the faster a height of the floating frame may decrease while keeping a width of the floating frame constant. The slower the negative feedback operation, the slower the height of the floating frame may decrease. Alternatively, the region area of the operation layer in the first form may be reduced at a constant speed. For example, the operation layer in the first form is a floating frame. As the operation distance of the negative feedback operation decreases, the height of the floating frame may be reduced at a constant speed.

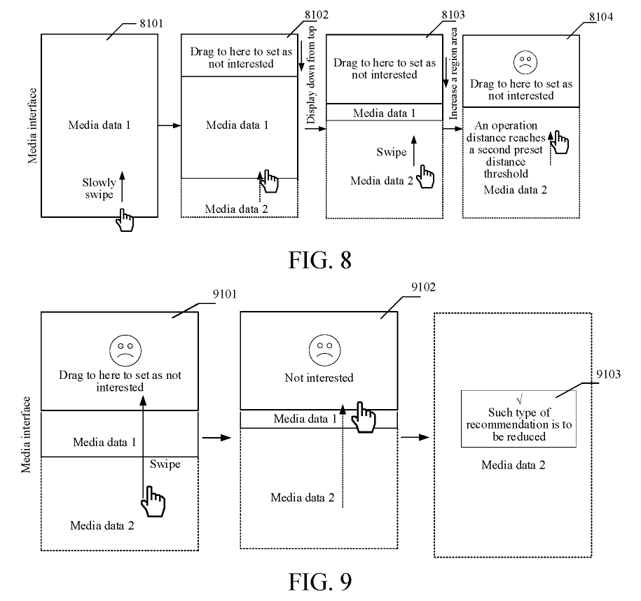

In a feasible implementation, the when the operation distance of the negative feedback operation changes, a display form of the operation layer in the first form may be controlled to change with change of the operation distance of the negative feedback operation further includes: setting a second preset distance threshold, and when the operation distance of the negative feedback operation reaches the second preset distance threshold (greater than the first preset distance threshold), controlling the operation layer to change from the first form to a second form. The second form and the first form are different display forms. A difference of between the display forms includes at least one of the following differences: a region area difference, a display position difference (e.g., the operation layer in the first form is displayed on an upper side of the media interface, and the operation layer in the second form is displayed on a lower side of the media interface), a display shape difference (e.g.., the operation layer in the first form is a floating window, and the operation layer in the second form is a floating ball), a display color difference (e.g.., the operation layer in the first form is translucent (whose transparency is 50%), and the operation layer in the second form is opaque (whose transparency is 0%)), or a display information difference (e.g.., the operation layer in the second form may include more graphic-textual information). In some embodiments, a region area and a display position of the operation layer in the second form may be a region area and a display position of the operation layer in the first form when the operation distance of the negative feedback operation reaches the second preset distance threshold. As shown in 8101 and 8102 in FIG. 8 (which is a diagram of an interaction scenario according to some embodiments of the present disclosure), when the finger of the object swipes upward on the media interface, the operation distance and the operation duration of the negative feedback operation may be obtained. When the operation distance of the negative feedback operation reaches the first preset distance threshold, and the operation duration of the negative feedback operation reaches the first preset duration threshold, the operation layer in the first form (namely, an interface shown in 8102 in FIG. 8) may be displayed on the media interface from top to bottom. When the negative feedback operation continues to swipe up, the region area of the operation layer in the first form (namely, an interface shown in 8103 in FIG. 8) may be increased. When the swipe operation of the negative feedback operation reaches the second preset distance threshold, the operation layer in the second form shown in 8104 in FIG. 8 may be displayed.

S403: Display a negative feedback result for the first media data when the operating status of the negative feedback operation meets the negative feedback condition.

The operating status of the negative feedback operation includes the operation position of the negative feedback operation. The negative feedback condition indicates that the operation position of the negative feedback operation is dynamically adjusted until the operation position of the negative feedback operation enters the operation layer in the first form. Alternatively, the negative feedback condition indicates that the operation position of the negative feedback operation is dynamically adjusted until the operation position of the negative feedback operation enters the operation layer in the second form. For example, when the operation position of the negative feedback operation is dynamically adjusted to enter the region of the operation layer (in the first form or the second form), it may be determined that the operating status of the negative feedback operation meets the negative feedback condition. In this case, the negative feedback result for the first media data may be displayed, and the operation layer (in the first form or the second form) is hidden. The negative feedback result may be configured for indicating that the negative feedback on the first media data succeeds. The negative feedback success indicates that interestingness of the object initiating the negative feedback operation on the first media data is less than the interest threshold (namely, it indicates that the object is not interested in the first media data). A form of the negative feedback result includes, but is not limited to, vibration feedback, audio-visual feedback, and graphic-textual feedback. For example, the negative feedback result includes vibration and text ("This type of recommendation is to be reduced"). The object may revoke the negative feedback operation after receiving the negative feedback result. Hiding the operation layer (in the first form or the second form) may include deleting the operation layer, or setting the transparency of the operation layer (in the first form or the second form) to be greater than a preset transparency threshold (e,g., 100%) (in this case, the display level of the operation layer (in the first form or the second form) also needs to be adjusted to be lower than the display level of the media interface, to avoid that an interaction operation on the media interface is incorrectly determined as an interaction operation on the operation layer (in the first form or the second form)).

In an implementation, when the operating status of the negative feedback operation does not meet the negative feedback condition, if the negative feedback operation is revoked, e,g., when the operation position of the negative feedback operation does not enter the region of the operation layer (in the first form or the second form), the negative feedback operation is revoked, and the operation layer (in the first form or the second form) is hidden. The operation layer (in the first form or the second form) may float on the media interface. Hiding the operation layer (in the first form or the second form) may include deleting the operation layer (in the first form or the second form), or changing a transparency parameter of the operation layer (in the first form or the second form), to cause the operation layer (in the first form or the second form) to be transparent (in this case, the display level of the operation layer (in the first form or the second form) also needs to be adjusted to be lower than the display level of the media interface, to avoid that an interaction operation on the media interface is incorrectly determined as an interaction operation on the operation layer (in the first form or the second form)).

In a feasible implementation, when the operating status of the negative feedback operation meets the negative feedback condition, the operation layer in the third form may be displayed. The operation layer in a third form presents a negative feedback ending condition. The negative feedback ending condition may be configured for prompting the object to recall the negative feedback operation (e,g., the finger is released, so that the finger that triggers the negative feedback operation leaves the media interface), to initiate the negative feedback on the first media data. A form of the negative feedback ending condition includes vibration feedback, graphic-textual feedback, and the like. When the operating status of the negative feedback operation meets the negative feedback ending condition (namely, when the negative feedback operation is revoked, it is determined that the negative feedback ending condition is met), the operation layer in a fourth form may be displayed, the operation layer in the fourth form presenting information indicating that the negative feedback succeeds, the third form and the fourth form being different display forms As shown in 9101 in FIG. 9 (which is a diagram of an interaction scenario according to some embodiments of the present disclosure), when the finger of the object swipes upward on the media interface and enters the operation layer in the second form, the finger of the object may vibrate and display the negative feedback ending condition shown in 9102 in FIG. 9. When the negative feedback operation is recalled, the operation layer in the fourth form shown by 9103 in FIG. 9 may be displayed. The operation layer in the fourth form may be hidden in response to that display duration of the operation layer in the fourth form reaches the second preset duration threshold, or in response to a media play operation on the media stream, and hiding the operation layer in the fourth form may include deleting the operation layer in the fourth form. Alternatively, a transparency parameter of the operation layer in the fourth form is changed, so that transparency of the operation layer in the fourth form is higher than a preset transparency threshold (the preset transparency threshold may be set based on an actual requirement, e.g., 80% or 90%), and the operation layer in the fourth form seems to be transparent.

In an implementation, if the negative feedback operation meets the negative feedback condition (namely, the operation position of the negative feedback operation enters the region of the operation layer in the second form, and in this case, the operation layer in the second form is changed into the operation layer in the third form), the negative feedback operation is maintained and swipes outside the region of the operation layer (namely, the operation location of the negative feedback operation is adjusted to be outside the region of the operation layer), and the operation layer in the third form is restored to the operation layer in the second form.

S404: Delete the first media data from the media stream if the negative feedback result indicates that negative feedback on the first media data succeeds, select second media data based on the operation direction of the negative feedback operation and an arrangement sequence of each piece of media data in the media stream, and present the second media data on the media interface.

In an implementation, when the negative feedback result of the first media data indicates that negative feedback on the first media data succeeds, the first media data may be deleted from the media stream, and the first media data displayed on the media interface is switched to second media data. The second media data may be selected based on the operation direction of the negative feedback operation and an arrangement sequence of each piece of media data in the media stream. For example, if the operation direction of the negative feedback operation is swiping up, the media data 1 on the media interface may be switched to be displayed as the media data 2 following media data 1 in the media stream. If the operation direction of the negative feedback operation is swiping down, the media data 1 on the media interface may be switched to be displayed as the media data 0 preceding the media data 1 in the media stream.

In an implementation, a media stream update request is transmitted to the server if the negative feedback result indicates that negative feedback on the first media data succeeds, and the media stream update request is configured for requesting the server to update the media stream based on the negative feedback result. The updated media stream is displayed on the media interface. A process in which the server updates the media stream based on the negative feedback result includes: obtaining, by the server, a target category to which the first media data belongs; deleting, by the server, media data belonging to the target category from the media stream; and obtaining, by the server, other media data not belonging to the target category from the media library, and adding the other media data to the media stream, to obtain an updated media stream. The target category of the first media data may include any one or more of the following target categories: a label that is self-defined when the first media data is uploaded, or a label that is marked through manual content analysis and machine content analysis.

In another implementation, when the operating status of the negative feedback operation does not meet the negative feedback condition, and the negative feedback operation is recalled (e,g., the finger is released, so that the finger that triggers the negative feedback operation leaves the media interface), it indicates that the object gives up performing negative feedback on the first media data, and the operation layer may be hidden. In this case, the first media data displayed on the media interface may further be switched to other media data based on the operation direction of the negative feedback operation and an arrangement sequence of each piece of media data in the media stream.

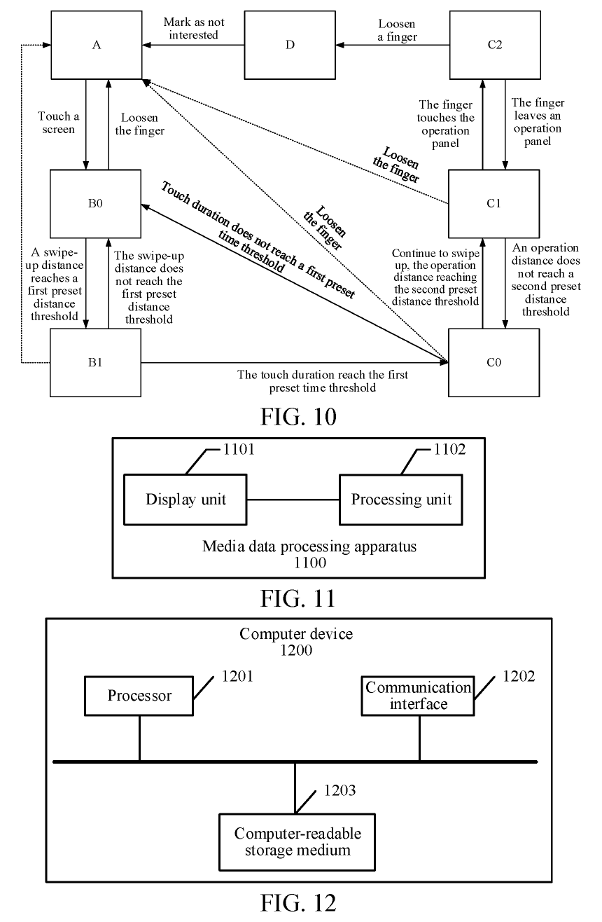

To recognize an intention of the object through the operation duration and the operation distance during each swipe operation of the object, some embodiments of the present disclosure is implemented through a state machine. The following uses an example in which a negative feedback operation is a swipe operation of swiping up, each time of operation is divided into the following states: A-initial state, B0-swiping-up distance recognition state, B1-swiping-up duration recognition state, C0-panel appearance state (namely, an operation layer in a first form), C1-panel expansion state (namely, as an operation distance of the negative feedback operation changes, a region area of the operation layer in the first form also changes, and when the operation distance of the negative feedback operation reaches a second preset distance, an operation layer in a second form is displayed), C2-panel selection state (namely, an operation layer in a third form), and D-not interested marked state (namely, an operation layer in a fourth modality). Referring to FIG. 10, FIG. 10 is an interaction flowchart according to some embodiments of the present disclosure. As shown in FIG. 10, before an object touches a screen, a state is the initial state A, and after a finger of the object starts to touch the screen, enters the swiping-up distance recognition state B0 is entered. When the swiping-up distance recognition state B0 is entered, a distance for which the finger of the object swipes upward on the screen is recognized. If a swiping-up distance of the object does not reach a first preset distance threshold, and a finger of the object leaves a screen (which is briefly referred to as releasing the finger), a media data switching event is triggered. If the swiping-up distance of the object reaches the first preset distance threshold, the swiping-up duration recognition state B1 is entered. If the swiping-up duration recognition state B1 is entered, touch duration of the finger of the object on the screen is recognized. If the touch duration does not reach the first preset time threshold, the media data switching event is triggered. If the touch duration reaches the first preset time threshold, the panel appearance state C0 is entered. When the panel appearance state C0 is entered, the operation layer in the first form at top is called out, and the object is prompted that the finger may be dragged to top to trigger a negative feedback event. If the object does not continue to drag the finger to top of a panel and releases the finger, the operation layer is collapsed, and the media data switching event is triggered. If the user continues to drag the finger upward, the panel expansion state C1 is entered. When the panel expanded state C1 is entered, a swiping-up distance of the finger of the object starts to be recognized, and the region area of the operation layer in the first form is synchronously increased based on the swiping-up distance. When the swiping-up distance reaches the second preset distance threshold, the operation layer is changed from the first form to the second form. If the finger of the object leaves the screen without touching the operation layer, the operation layer is collapsed, and the media data switching event is triggered. If the object continues to drag the finger upward, and the finger touches the operation layer, the panel selection state C2 is entered. After the panel selection state C2 is entered, an icon and text of the operation layer are changed, and the object is prompted to release the finger to trigger the negative feedback event (namely, a negative feedback end condition). If the object releases the finger in a region of the operation layer, the not interested marked state D is entered. If the finger of the object swipes downward and leaves the region of the operation layer, the state returns to the panel expansion state C1. After the not interested marked state D is entered, a terminal device initiates a marking request to the server, to mark correspondingly browsed media data as being not interested. After the media data is successfully marked, the media data is removed from a current media stream, the operation panel at the top is collapsed simultaneously, and subsequent pushing of media data of the same type is reduced, and finally, the state returns to the initial state A. The object first swipes slowly for a short distance, so that the operation layer in the first form may be triggered to be displayed, and the operation layer in the first form may be configured for beginner education, to guide learning of an object that use a negative feedback function for a first time. In a process in which the object continues to swipe, the region area of the operation layer in the first form may be gradually increased, to accommodate the finger of the object, facilitating operation performed by an object having a negative feedback intention. After the finger of the object touches the operation layer, negative feedback succeeds after the finger of the object is vibrated and prompted to leave the screen. Currently displayed media data is swiped away, and next media data is pushed. An overall interaction process is smooth and natural and conforms to cognition and habits of the object, to reduce complexity of operation performed by the object and improve negative feedback efficiency for the media data.

In some embodiments of the present disclosure, a media interface may be displayed. The media interface is configured for presenting a media stream. When a negative feedback operation on first media data in the media stream is detected, an operation layer is displayed, where a negative feedback condition is presented on the operation layer. In view of this, in the present disclosure, the operation layer may be actively displayed after a negative feedback intention of an object is recognized, and the object does not need to additionally search for a menu or function, thereby shortening a negative feedback setting path. In addition, the negative feedback condition is further presented on the operation layer. The negative feedback condition can guide an operating status of the negative feedback operation, thereby simplifying operation complexity of the negative feedback operation. A negative feedback result for the first media data is displayed when the operating status of the negative feedback operation meets the negative feedback condition. Through guidance of the negative feedback condition, the negative feedback result for the first media data may be smoothly obtained, thereby implementing efficient negative feedback on media data, and effectively improving efficiency of negative feedback on the media data.

Referring to FIG. 11, FIG. 11 is a schematic structural diagram of a media data processing apparatus according to some embodiments of the present disclosure. The foregoing media data processing apparatus is run on a terminal device. Exemplarily, the media data processing apparatus may be a computer program (including program code) running on the terminal device. The media data processing apparatus may be configured to perform corresponding operations in the method according to some embodiments of the present disclosure. As shown in FIG. 11, the media data processing apparatus 1100 may include at least one of the following units: a display unit 1101 and a processing unit 1102.

The display unit 1101 is configured to display a media interface, media interface being configured for presenting a media stream;

the display unit 1101 is further configured to display an operation layer in response to a negative feedback operation on first media data in the media stream, a negative feedback condition being presented on the operation layer; and

the display unit 1101 is further configured to display a negative feedback result for the first media data when an operating status of the negative feedback operation meets the negative feedback condition.

In an implementation, the operating status of the negative feedback operation includes operation duration and an operation distance. The display unit 1101 is configured to perform the following operation when the operation layer is displayed in response to the negative feedback operation on the first media data in the media stream:

triggering to display an operation layer in a first form when the operation duration of the negative feedback operation reaches a first preset duration threshold and the operation distance of the negative feedback operation reaches a first preset distance threshold, the negative feedback condition being presented on the operation layer in the first form.

In an implementation, the operating status of the negative feedback operation further includes an operation direction, and the operation direction includes a first direction along the media interface; and the display unit 1101 is configured to perform the following operation when the display unit 1101 is configured to trigger to display the operation layer in the first form:

displaying the operation layer in the first form in a second direction along the media interface,

the second direction being different from the first direction, or the second direction being an opposite direction of the first direction.

In an implementation, the foregoing media data processing apparatus further includes a processing unit 1102, and the processing unit 1102 is configured to perform the following operation:

controlling a display form of the operation layer to change with a change of the operation distance when the operation distance of the negative feedback operation changes.

In an implementation, when controlling the display form of the operation layer to change with the change of the operation distance when the operation distance of the negative feedback operation changes, the processing unit 1102 is configured to perform the following operations:

synchronously increasing a region area of the operation layer in the first form with increase of the operation distance of the negative feedback operation when the operation distance of the negative feedback operation is greater than the first preset distance threshold;

synchronously reducing the region area of the operation layer in the first form with decrease of the operation distance of the negative feedback operation when the operation distance of the negative feedback operation is greater than the first preset distance threshold; and

controlling the operation layer to change from the first form to a second form when the operation distance of the negative feedback operation reaches a second preset distance threshold, the second preset distance threshold being greater than the first preset distance threshold,

the second form and the first form being different display forms, a difference between the display forms including at least one of the following differences: a region area difference, a display position difference, a display shape difference, a display color difference, or a display information difference.

In an implementation, the operating status of the negative feedback operation includes an operation position. The negative feedback condition is configured for indicating that an operation position of the negative feedback operation is dynamically adjusted until the operation position enters a region of the operation layer; and

the display unit 1101 is configured to perform the following operation when displaying the negative feedback result for the first media data when the operating status of the negative feedback operation meets the negative feedback condition:

displaying the negative feedback result for the first media data when the operation position of the negative feedback operation enters the region of the operation layer after being dynamically adjusted, the negative feedback result being configured for indicating that negative feedback on the first media data succeeds, the negative feedback success indicating that interestingness of an object initiating the negative feedback operation on the first media data is less than an interest threshold.

In an implementation, the operating status of the negative feedback operation further includes the operation direction. The display unit 1101 is further configured to perform the following operations:

deleting the first media data from the media stream if the negative feedback result indicates that the negative feedback on the first media data succeeds;

selecting second media data from the media stream based on the operation direction and an arrangement sequence of each piece of media data in the media stream; and

presenting the second media data on the media interface.

In an implementation, the display unit 1101 is further configured to perform the following operations:

transmitting a media stream update request to a server if the negative feedback result indicates that the negative feedback on the first media data succeeds, the media stream update request being configured for requesting the server to update the media stream based on the negative feedback result; and

playing an updated media stream on the media interface.

In an implementation, a process in which the server updates the media stream based on the negative feedback result includes:

obtaining, by the server, a target category to which the first media data belongs;

deleting, by the server, all media data belonging to the target category from the media stream; and

obtaining, from a media library by the server, other media data not belonging to the target category, and adding the other media data to the media stream, to obtain an updated media stream.

In an implementation, the display unit 1101 is further configured to perform the following operations:

displaying an operation layer in a third form when the operating status of the negative feedback operation meets the negative feedback condition, a negative feedback ending condition being presented on the operation layer in the third form;

displaying an operation layer in a fourth form when the operating status of the negative feedback operation meets the negative feedback ending condition, information indicating that the negative feedback succeeds being presented on the operation layer in the fourth form, and the third form and the fourth form being different display forms; and

hiding the operation layer in response to that display duration of the operation layer in the fourth form reaches a second preset duration threshold or in response to a media playing operation on the media stream.

In an implementation, the display unit 1101 is further configured to perform the following operation:

hiding the operation layer if the negative feedback operation is revoked when the operating status of the negative feedback operation does not meet the negative feedback condition.

In an implementation, the operation layer floats on the media interface, and a region area of the operation layer is smaller than an area of a display region of the media interface; and

When the display unit 1101 is configured to hide the operation layer, the display unit 1101 is configured to perform the following operations:

deleting the operation layer; or

changing a transparency parameter of the operation layer, to cause transparency of the operation layer to be higher than a preset transparency threshold.

In an implementation, the operating status of the negative feedback operation further includes the operation direction. The display unit 1101 is further configured to perform the following operations:

selecting, when the operation duration of the negative feedback operation does not reach the first preset duration threshold, or the operation distance of the negative feedback operation does not reach the first preset distance threshold, third media data based on an arrangement sequence of each piece of media data in the media stream in the operation direction; and

presenting the third media data on the media interface.

According to some embodiments of the present disclosure, each unit of a data management apparatus of the spatial adjustment object shown in FIG. 11 may be separately or wholly combined into one or several other units, or one (or more) of the units herein may further be divided into a plurality of units of smaller functions. In this way, same operations can be implemented, and implementation of the technical effects of some embodiments of the present disclosure is not affected. The foregoing units are divided based on logical functions. In an actual application, a function of one unit may also be implemented by a plurality of units, or functions of a plurality of units are implemented by one unit. In another embodiment of the present disclosure, the data management apparatus of the spatial adjustment object may further include another unit. In an actual application, these functions may also be cooperatively application by another unit and may be cooperatively implemented by the plurality of units. According to another embodiment of the present disclosure, a computer program (including program code) that can perform the operations in the foregoing corresponding methods may be run on a general computing device, such as a computer, which includes processing elements and storage elements such as a central processing unit (CPU), a random access memory (RAM), and a read-only memory (ROM), to construct the media data processing apparatus as shown in FIG. 11, and to implement the data management method for the spatial adjustment object according to some embodiments of the present disclosure. The computer program may be recorded in, e,g., a computer-readable recording medium, and may be loaded into the foregoing computing device through the computer-readable recording medium, and run in the computing device.

In some embodiments of the present disclosure, a media interface may be displayed. The media interface is configured for presenting a media stream. When a negative feedback operation on first media data in the media stream is detected, an operation layer is displayed, where a negative feedback condition is presented on the operation layer. In view of this, in the present disclosure, the operation layer may be actively displayed after a negative feedback intention of an object is recognized, and the object does not need to additionally search for a menu or function, thereby shortening a negative feedback setting path. In addition, the negative feedback condition is further presented on the operation layer. The negative feedback condition can guide an operating status of the negative feedback operation, thereby simplifying operation complexity of the negative feedback operation. A negative feedback result for the first media data is displayed when the operating status of the negative feedback operation meets the negative feedback condition. Through guidance of the negative feedback condition, the negative feedback result for the first media data may be smoothly obtained, thereby implementing efficient negative feedback on media data, and effectively improving efficiency of negative feedback on the media data.

One or more components of FIG. 11 may be integrated into a single component, or conversely, a single component may be implemented as multiple discrete elements. Additionally or alternatively, different subsets of the illustrated components may be combined in various configurations.

FIG. 12 is a schematic structural diagram of a computer device according to some embodiments of the present disclosure. Referring to FIG. 12, the computer device 1200 includes a processor 1201, a communication interface 1202, and a computer-readable storage medium 1203. The processor 1201, the communication interface 1202, and the computer-readable storage medium 1203 may be connected through a bus or in another manner. The communication interface 1202 is configured to receive and transmit data. In some embodiments, the communication interface 1202 may include a standard wired interface and a standard wireless interface (e.g., WiFi and a mobile communication interface) and is controlled by the processor 1201 to be configured to transmit and receive data. The computer-readable storage medium 1203 may be stored in a memory (which may include a built-in memory of the computer device 1200 and certainly may also include an extended memory supported by the computer device 1200) of the computer device 1200. The computer-readable storage medium 1203 is configured to have a computer program stored therein. The computer program includes program instructions. The processor 1201 is configured to execute the program instructions stored in the computer-readable storage medium 1203. The processor 1201 (or referred to as a central processing unit (CPU)) is a computing core and a control core of the computer device 1200. The processor 1201 may analyze various instructions in the computer device 1200 and process various data in the computer device 1200. The processor 1201 is suitable for implementing one or more instructions, and for loading and executing the one or more instructions, to implement a corresponding method process or a corresponding function.

Some embodiments of the present disclosure further provides a computer-readable storage medium (memory), and the computer-readable storage medium is a memory device in the computer device 1200 and is configured to have a program and data stored therein. The computer-readable storage medium herein may include an internal storage medium of the computer device 1200 and certainly may also include an extended storage medium supported by the computer device 1200. The computer-readable storage medium provides storage space, and the storage space has a processing system of the computer device 1200 stored therein. In addition, the storage space further stores one or more instructions suitable for being loaded and executed by the processor 1201. The instructions may be one or more computer programs (including program code). The computer-readable storage medium herein may be a high-speed RAM or a non-volatile memory, e,g., at least one magnetic disk memory. In some embodiments, the computer-readable storage medium may further be at least one computer-readable storage medium located away from the foregoing processor.

In some embodiments, the computer-readable storage medium has one or more instructions stored therein; and the one or more instructions stored in the computer-readable storage medium is loaded and executed by the processor 1201, to implement the corresponding operation according to the foregoing media data processing method embodiments.

Based on the same inventive conception, a principle and a conducive effect of resolving a problem by the computer device 1200 according to some embodiments of the present disclosure is similar to a principle and a conducive effect of resolving a problem by the media data processing method in the method embodiments of the present disclosure. Reference may be made to implementation of the method. For brevity, details are not described herein again.

One or more components of FIG. 12 may be integrated into a single component, or conversely, a single component may be implemented as multiple discrete elements. Additionally or alternatively, different subsets of the illustrated components may be combined in various configurations.

In some embodiments of the present disclosure, a term "module" or "unit" refers to a computer program having a predetermined function or a part of a computer program, which works together with other relevant parts to achieve a predetermined objective, and may be all or partially implemented through software, hardware (e.g., a processing circuit or a memory), or a combination thereof. Similarly, one processor (or a plurality of processors or memories) may be configured to implement one or more modules or units. In addition, each module or unit may be a part of an overall module or unit including a function of the module or the unit.

Some embodiments of the present disclosure further provide a computer program product or a computer program. The computer program product or the computer program includes computer instructions, the computer instructions being stored in a computer-readable storage medium. A processor of a computer device reads the computer instructions from the computer-readable storage medium, and executes the computer instructions, to cause the computer device to perform the foregoing media data processing method.

An object of ordinary skill in the art may be aware that the exemplary units and algorithm operations described with reference to some embodiments disclosed in the present disclosure can be implemented in electronic hardware, or a combination of computer software and electronic hardware. Whether these functions are executed in a manner of hardware or software depends on particular applications and design constraint conditions of the technical solutions. An object of professional skill in the art may use different methods to implement the described functions for each particular application, but it is not to be considered that the implementation goes beyond the scope of the present disclosure.

In the present disclosure, the use of singular designations for elements is intended to represent "one or more" rather than "one and only one", unless specifically stated. In the present disclosure, unless otherwise specified, "at least one" is intended to represent "one or more", and "a plurality of" is intended to represent "two or more".

All or some of the foregoing embodiments may be implemented through software, hardware, firmware, or any combination thereof. When software is used for implementation, implementation may be entirely or partially performed in the form of a computer program product. The computer program product includes one or more computer instructions. When the computer program instructions are loaded and executed on a computer, all or some of procedures or functions according to some embodiments of the present disclosure are generated. The computer may be a general-purpose computer, a special-purpose computer, a computer network, or another programmable device. The computer instructions may be stored in the computer-readable storage medium, or transmitted through the computer-readable storage medium. The computer instruction may be transmitted from a website, a computer, a server, or a data center to another website, computer, server, or data center in a wired (e,g., a coaxial cable, an optical fiber, or a digital subscriber line (digital subscriber line, DSL)) or wireless (e,g., infrared, radio, or microwave) manner. The computer-readable storage medium may be any available medium accessible by a computer, or a management device that integrates one or more available media, such as a server, a data center, or another spatial adjustment object. The available medium may be a magnetic medium (e.g., a floppy disk, a hard disk, or a magnetic tape), an optical medium (e,g., a DVD), a semiconductor medium (e,g., a solid state disk, (SSD)), or the like.

The foregoing descriptions are only specific implementations of the present disclosure, but are not intended to limit the protection scope of the present disclosure. Any variation or replacement readily figured out by the object of ordinary skill in the art within the technical scope disclosed in the present disclosure shall fall within the protection scope of the present disclosure. Therefore, the protection scope of the present disclosure shall be subject to the appended claims.

What is claimed is:

1. A media data processing method, performed by a terminal device, the media processing method comprising:
displaying a media interface configured to present a media stream;
displaying an operation layer based on a negative feedback operation on first media data in the media stream, a negative feedback condition being presented on the operation layer; and
displaying a negative feedback result for the first media data based on an operating status of the negative feedback operation meeting the negative feedback condition.

2. The media processing method according to claim 1, wherein the operating status of the negative feedback operation comprises an operation duration and an operation distance,
wherein the displaying of the operation layer comprises displaying the operation layer in a first form based on the operation duration of the negative feedback operation reaching a first preset duration threshold and the operation distance of the negative feedback operation reaching a first preset distance threshold, and wherein the negative feedback condition is presented on the operation layer in the first form.

3. The media processing method according to claim 2, wherein the operating status of the negative feedback operation comprises an operation direction,
wherein the operation direction comprises a first direction along the media interface,
wherein the displaying of the operation layer in the first form comprises displaying the operation layer in the first form in a second direction along the media interface, and
wherein the second direction being different from the first direction, or the second direction being an opposite direction of the first direction.

4. The media processing method according to claim 2, further comprising:
controlling a display form of the operation layer based on a change of the operation distance of the negative feedback operation.

5. The media processing method according to claim 4, wherein the controlling of the display form of the operation layer comprises:
synchronously increasing a region area of the operation layer in the first form with an increase in the operation distance of the negative feedback operation based on the operation distance of the negative feedback operation being greater than the first preset distance threshold;
synchronously reducing the region area of the operation layer in the first form with a decrease in the operation distance of the negative feedback operation based on the operation distance of the negative feedback operation being greater than the first preset distance threshold; and
controlling the operation layer to change from the first form to a second form based on the operation distance of the negative feedback operation reaching a second preset distance threshold, the second preset distance threshold being greater than the first preset distance threshold,
wherein the second form and the first form are different display forms, and
wherein a difference between the different display forms comprising at least one of: a region area difference, a display position difference, a display shape difference, a display color difference, or a display information difference.

6. The media processing method according to claim 3, wherein the operating status of the negative feedback operation comprises an operation position,
wherein the negative feedback condition is configured to indicate that the operation position of the negative feedback operation is dynamically adjusted until the operation position enters a region of the operation layer, and
wherein the displaying of the negative feedback result for the first media data comprises displaying the negative feedback result for the first media data based on the operation position of the negative feedback operation entering the region of the operation layer after being dynamically adjusted, the negative feedback result configured to indicate that negative feedback on the first media data succeeds, and an interest level of an object initiating the negative feedback operation on the first media data is less than an interest threshold.

7. The media processing method according to claim 6, wherein the operating status of the negative feedback operation comprises the operation direction, and
wherein the media processing method further comprises:
deleting the first media data from the media stream based on the negative feedback result indicating that the negative feedback on the first media data succeeds;
selecting second media data from the media stream based on the operation direction and an arrangement sequence of each piece of media data in the media stream; and
presenting the second media data on the media interface.

8. The media processing method according to claim 7, further comprising:
transmitting a media stream update request to a server based on the negative feedback result indicating that the negative feedback on the first media data succeeds, the media stream update request configured to request the server to update the media stream based on the negative feedback result; and
playing an updated media stream on the media interface.

9. The media processing method according to claim 8, wherein that the updating of the media stream comprises:
obtaining, by the server, a target category to which the first media data belongs;
deleting, from the media stream by the server, media data belonging to the target category;
obtaining, by the server, other media data not belonging to the target category from media library; and
adding the other media data to the media stream, to obtain the updated media stream.

10. The media processing method according to claim 7, further comprising:
displaying the operation layer in a third form based on the operating status of the negative feedback operation meeting the negative feedback condition, a negative feedback ending condition being presented on the operation layer in the third form;
displaying the operation layer in a fourth form based on the operating status of the negative feedback operation meeting the negative feedback ending condition, information indicating that the negative feedback succeeds being presented on the operation layer in the fourth form presenting,the third form and the fourth form being different display forms; and
hiding the operation layer based on display duration of the operation layer in the fourth form reaching a second preset duration threshold or a media playing operation on the media stream.

11. The media processing method according to claim 1, further comprising:
hiding the operation layer based on the negative feedback operation being revoked when the operating status of the negative feedback operation does not meet the negative feedback condition.

12. The media processing method according to claim 1, wherein the operation layer floats above the media interface,
wherein a region area of the operation layer is smaller than an area of a display region of the media interface and
wherein the hiding the operation layer comprises:
deleting the operation layer; or
changing a transparency parameter of the operation layer, to cause transparency of the operation layer to be higher than a preset transparency threshold.

13. The media processing method according to claim 7, wherein the operating status of the negative feedback operation comprises at least one of the operation duration, the operation distance, or the operation direction, and
wherein the method further comprises:
based on the operation duration of the negative feedback operation not reaching the first preset duration threshold, or the operation distance of the negative feedback operation not reaching the first preset distance threshold, selecting third media data based on the operation direction and the arrangement sequence of each piece of media data in the media stream; and
presenting the third media data on the media interface.

14. A media data processing apparatus, comprising:
at least one memory configured to store computer program code; and at least one processor configured to read the program code and operate as instructed by the program code, the program code comprising:
display code configured to cause the at least one processor to:
display a media interface, the media interface being configured for presenting a media stream;
display an operation layer based on a negative feedback operation on first media data in the media stream, a negative feedback condition being presented on the operation layer; and
display a negative feedback result for the first media data based on an operating status of the negative feedback operation meeting the negative feedback condition.

15. The media data processing apparatus according to claim 14, wherein the operating status of the negative feedback operation comprises an operation duration and an operation distance,
wherein the display code is configured to further cause the at least one processor to display the operation layer in a first form based on the operation duration of the negative feedback operation reaching a first preset duration threshold and the operation distance of the negative feedback operation reaching a first preset distance threshold, and
wherein the negative feedback condition is presented on the operation layer in the first form.

16. The media data processing apparatus according to claim 15, wherein the operating status of the negative feedback operation comprises an operation direction,
wherein the operation direction comprises a first direction along the media interface,
wherein the displaying of the operation layer in the first form comprises displaying the operation layer in the first form in a second direction along the media interface, and
wherein the second direction being different from the first direction, or the second direction being an opposite direction of the first direction.

17. The media data processing apparatus according to claim 15, wherein the display code is configured to further cause the at least one processor to control a display form of the operation layer based on a change of the operation distance of the negative feedback operation.

18. The media data processing apparatus according to claim 16, wherein the display code is configured to further cause the at least one processor to:
synchronously increase a region area of the operation layer in the first form with an increase in the operation distance of the negative feedback operation based on the operation distance of the negative feedback operation being greater than the first preset distance threshold;
synchronously reduce the region area of the operation layer in the first form with a decrease in the operation distance of the negative feedback operation based on the operation distance of the negative feedback operation being greater than the first preset distance threshold; and
control the operation layer to change from the first form to a second form based on the operation distance of the negative feedback operation reaching a second preset distance threshold, the second preset distance threshold being greater than the first preset distance threshold,
wherein the second form and the first form are different display forms, and
wherein a difference between the different display forms comprising at least one of: a region area difference, a display position difference, a display shape difference, a display color difference, or a display information difference.

19. The media data processing apparatus according to claim 18, wherein the operating status of the negative feedback operation comprises an operation position,
wherein the negative feedback condition is configured to indicate that the operation position of the negative feedback operation is dynamically adjusted until the operation position enters a region of the operation layer, and
wherein the display code is configured to further cause the at least one processor to display the negative feedback result for the first media data based on the operation position of the negative feedback operation entering the region of the operation layer after being dynamically adjusted, the negative feedback result configured to indicate that negative feedback on the first media data succeeds, and an interest level of an object initiating the negative feedback operation on the first media data is less than an interest threshold.

20. A non-transitory computer-readable storage medium, storing computer program code, when executed by at least one processor, causes the at least one processor to at least:
display a media interface, the media interface being configured for presenting a media stream;
display an operation layer based on a negative feedback operation on first media data in the media stream, a negative feedback condition being presented on the operation layer; and
display a negative feedback result for the first media data based on an operating status of the negative feedback operation meeting the negative feedback condition.
